(19) United States
(12) Patent Application Publication
(10) Pub. No.: US 2015/0350690 A1
(43) Pub. Date: Dec. 3, 2015

(54) IMPLEMENTING SCREEN SHARING FUNCTIONALITY OVER A COMMUNICATION NETWORK

(71) Applicant: SONIFI Solutions, Inc., Sioux Falls, SD (US)

(72) Inventors: Derin Michael Zerr, Kahului, HI (US); Leon P. Stoel, Sioux Falls, SD (US)

(21) Appl. No.: 14/728,831

(22) Filed: Jun. 2, 2015

Related U.S. Application Data
(60) Provisional application No. 62/006,400, filed on Jun. 2, 2014.
(60) Provisional application No. 62/015,205, filed on Jun. 20, 2014.

(51) Int. Cl. H04N 21/214; H04N 21/4363; H04N 21/414

(52) U.S. Cl. CPC H04N 21/2143; H04N 21/41407; H04N 21/43637

(57) ABSTRACT

Methods and systems for enabling a screen sharing functionality of an output device are provided. More particularly, one or more first commands may be provided to a headend from a mobile device. The headend may then provide one or more second commands to an output device to enable a screen sharing functionality of the output device. Additional configuration parameters may be received at the headend from the mobile device and provided to the output device to change, for instance, a broadcast name of the output device. Content may then be streamed directly from the mobile device to the output device using a direct device-to-device communication protocol.

### CROSS-REFERENCE TO RELATED APPLICATIONS

This application claims the benefit of U.S. Provisional Patent Application Ser. No. 62/006,400, filed Jun. 2, 2014 and U.S. Provisional Patent Application Ser. No. 62/015,205, filed Jun. 20, 2014, the entire disclosures of each of which are hereby incorporated herein by reference in their entirety.

### FIELD

Systems and methods for enabling a function of an output device and subsequently delivering content to the output device utilizing a screen sharing solution are provided.

### BACKGROUND

Increasingly, video entertainment, such as movies and television shows, is delivered to users on demand over digital networks. In addition, the distribution of content has expanded to include mobile devices, such as smart phones. These mobile devices have the ability to interface with content delivery systems, and to output video and other content to users. However, because of the need for mobility, the output capabilities of mobile devices are necessarily limited. Therefore, it is desirable to direct content streams associated with a mobile device to televisions or home theater systems.

Systems and methods currently available include establishing a dedicated connection between a mobile device and an output device. However, such dedicated connections can be limited by controls put in place by digital rights management systems and further are not always compatible with existing entertainment systems. In addition, where multiple output devices are potentially available in the vicinity of the mobile device, determining which output device to select and providing content to the selected output device may be problematic, particularly in a hotel, other hospitality or Multiple Dwelling Unit setting.

### SUMMARY

Embodiments of the present disclosure are directed to systems and methods for implementing screen sharing functionality (Miracast, for example) over a communication network. The communication network may be wired or wireless and may include RF delivery over COAX including b-LAN used by SONIFI Solutions, Inc. Screen sharing solutions may include peer-to-peer wireless screencasting implemented using direct device-to-device communications, such as Wi-Fi Direct; accordingly, access to a Wi-Fi network is not needed to connect and share content to screen sharing capable devices. For example, a mobile user device, such as a smart phone, smart pad, or computer, may directly stream content, such as multimedia content, to an output device, such as a TV or other device capable of displaying such content utilizing a screen sharing solution, such as Miracast. However, in some environments, particularly in those of a hotel, hospitality, or other Multiple Dwelling Unit setting, the ability to access and configure screen sharing capabilities of the output device is not readily available. For instance, a guest in a hotel may not be able to directly access Miracast settings for the TV in their hotel room. Accordingly, if Miracast is disabled at the TV, the guest has no way of enabling the Miracast capability in order to stream content from a mobile device to the TV.

Moreover, in some instances, such as in a Multiple Dwelling Unit setting, once a Miracast capability has been enabled, a guest may have no way of knowing which Miracast enabled TV to select in order to share content. For example, in a hotel, there may be multiple Miracast enabled TVs having a screen sharing capability within a range of a mobile device.

Accordingly, an exemplary system, in accordance with at least one embodiment of the present disclosure, includes a distribution network, a mobile device, a content provider, and an output device, wherein one or more first commands are received at a headend of the distribution network, the one or more first commands indicating that a screen sharing functionality of the output device is to be configured, wherein the headend device provides one or more second commands to the output device over a communication network such that the received one or more second commands at the output device configures the screen sharing functionality of the output device. In some instances the one or more first commands may be provided from at least one of the mobile device and a remote control device, such as a remote control device that provides commands to the output device and/or the headend of the distribution network.

Methods in accordance with embodiments of the present disclosure include receiving, at an output device, one or more first commands that enable the screen sharing functionality, providing the received one or more first commands to a headend of a distribution network utilizing a communication network, providing one or more second commands based on the one or more first commands to the output device, the one or more second commands enabling one or more screen sharing capabilities of the output device, and providing one or more third commands to the output device, the one or more third commands modifying one or more Miracast configuration settings of the output device. The output device may then broadcast itself as an output device capable of receiving content using a direct device-to-device communication manner, such as Miracast, utilizing a broadcast name based on the one or more third commands. Moreover, a user may then utilize their mobile device to stream content, generally provided by a content provider, to the screen sharing enabled output device.

### BRIEF DESCRIPTION OF THE DRAWINGS

FIG. 1 depicts a system for enabling screen sharing functionality of an output device in accordance with embodiments of the present disclosure;

FIG. 2 depicts a process for enabling screen sharing functionality of an output device using a system as depicted in FIG. 1;

FIG. 3 depicts one or more configuration settings that may be altered in accordance with embodiments of the present disclosure;

FIG. 4 depicts a process for enabling screen sharing functionality of an output device and altering a configuration setting using a system as depicted in FIG. 1;

FIG. 5 depicts aspects of a mobile device in accordance with embodiments of the present disclosure; and

FIG. 6 depicts aspects of an output device in accordance with embodiments of the present disclosure.

### DETAILED DESCRIPTION

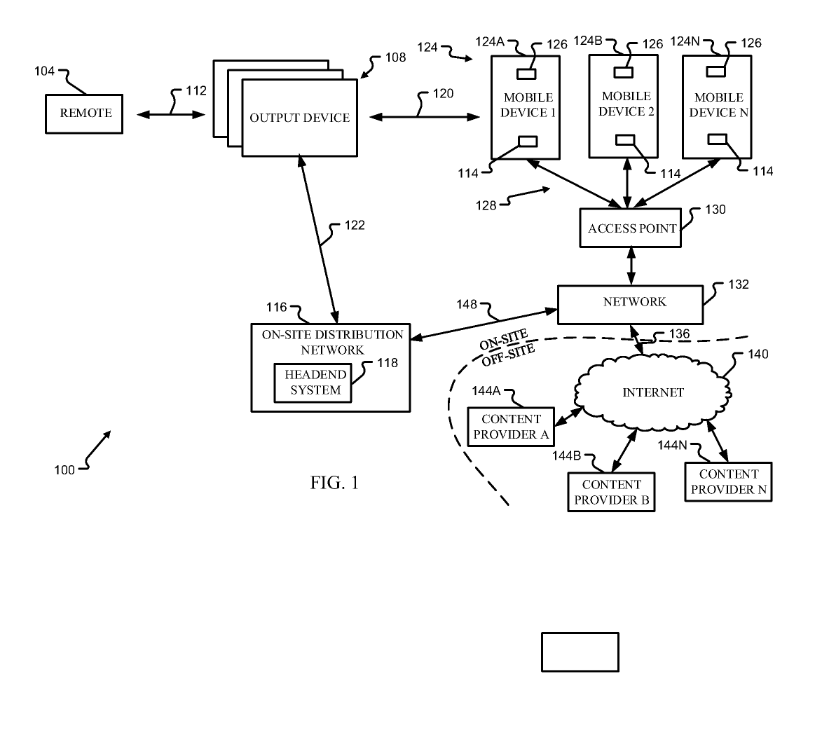

FIG. 1 illustrates a system 100 for implementing a screen sharing functionality, such as Miracast, utilizing a communication network 120 and a Broadband Local Area Network (b-LAN) communication network. In general, the system 100 includes one or more mobile devices 124A-N, a first network 132, a second network 140, an on-site distribution network 116, and one or more output devices 108. Utilizing system 100, for example, Miracast may be used as a peer-to-peer wireless screencasting solution implemented using Wi-Fi Direct communications; accordingly, access to a Wi-Fi network is not needed to connect and share content to Miracast capable devices, such as an output device 108.

The mobile devices 124 may, for example, include smart phones, tablets, laptops, or any other devices that are capable of accessing content from and communicating with one or more content providers 144A-N. A mobile device 124 may additionally be capable of supporting the selection of content available from a content provider 144. For example, the mobile device 124 may access content using a web browser, through execution of a content provider app 114, and/or the receipt of user input. Accordingly, the mobile device 124 may include memory to store application programming, user data and credentials, and other information, a processor for executing the application programming, a user input, a user output, and a communication interface for supporting the delivery and receipt of data and instructions to and from a network or networks, such as the network 132.

In accordance with some embodiments of the present disclosure, the mobile device 124 may support the selection of content available from a content provider 144. Examples of content providers include, but are not limited to Netflix™, Pandora™, YouTube™, and HBO GO™. Moreover, the mobile devices 124 may further include the capability to share content with one or more output devices 108, such as a hotel TV, utilizing a point-to-point, or peer-to-peer, content sharing solution such as Miracast 120. For example, a user may utilize a mobile device 124 to share, utilizing a Miracast 120 connection, multimedia, such as photos, videos, or other contents, potentially from one or more content providers 144, with one or more output devices 108, such as a hotel TV.

In accordance with some embodiments of the present disclosure, a user may execute a screen sharing functionality using a web browser, through execution of a screen sharing app 126, and/or at the receipt of user input, for example, by altering a configuration setting of the mobile device 124. That is, a screen sharing app 126 may provide the necessary functionality to share the screen, or output, of the mobile device 124 with one or more output devices 108. Alternatively, or in addition, the user of the mobile device 124 may select or enable a configuration setting enabling a screen sharing functionality at the mobile device 124. Since a screen sharing solution, such as Miracast, does not rely upon a specific wireless or wired network connection, such as a connection to a wireless network 128 provided by one or more hotel access points 130, a user may simply rely upon a peer-to-peer connection, utilizing Miracast 120 over Wi-Fi Direct, to share content from the mobile device 124 to the one or more output devices 108.

In accordance with embodiments of the present disclosure, the user may operate the mobile device 124 to access one or more content providers 144 over one or more networks and provide such content to the one or more output devices 108. For example, in a hotel environment, a wireless network connection 128 may be provided by one or more wireless access points 130 in communication with one or more routers of an in-hotel network located on the premises of the hotel. Such an in-hotel network may be considered the first network 132. The first network 132 may comprise a local area network, or a wide area network. An example of a local area network is a network associated with a hotel or other hospitality facility, and can include a Wi-Fi network, a wired Ethernet network, or any other network technology. An example of a wide area network is a cellular telephony network. In general, the first network 132 is operable to support communications between at least a mobile device 124 and the content provider 144.

Accordingly, the mobile device 124 may access the Internet, or second network, 140 utilizing the hotel's existing Internet connection 136 in order to access content providers 144. The system 100 topology facilitates the delivery of content to mobile device 124 by providing a relatively high bandwidth channel over which content can be delivered from a content provider 144. Alternatively, or in addition, the mobile communication device 124 may utilize a different network connection, such as a GSM network, cellular network, or similar network to access content providers 144 available via the Internet 140.

The on-site distribution network 116 may include an on-premises network, and may comprise a first network section 122 in the form of, for example, a radio frequency (RF) or Internet Protocol (IP) section that delivers QAM modulated content to a selected output device 108. Such a first network section 122 may include a coax Broadband Local Area Network (b-LAN). In particular, the on-site distribution network 116 may provide content, such as content from one or more headend system 118, to the output device 108. The headend system 118 may refer to a system that receives content from one or more sources and distributes such content to one or output devices 108.

Although a screen sharing capability, such as Miracast, may be provided by and/or built into the one or more output devices 108, there is generally an issue of controlling functionality of the screen sharing capability in some environments. For example, in a hotel environment, the output device 108, such as the hotel TV, may not allow a user, or guest, direct access to screen sharing controls or functionality. That is, a user may not be able to directly enable a screen sharing functionality utilizing an in-room remote 104 or other buttons or keys located in or around the output device 108. Such restrictions may be in place as part of a security protocol or other prohibitive measure to guide a user experience. For example, if a user had access to all functionality of the hotel TV 108, often times configuration settings may be modified such that the hotel TV 108 no longer is operable for its intended purpose. This often results in a less than impressive experience for a user. Accordingly, the ability to enable a screen sharing functionality in such an environment may be restricted. In addition, other configuration settings of the output device 108 related to the screen sharing functionality may be restricted. For example, the broadcast name of the output device, such as a Miracast sink name, may not be readily configurable. Therefore, in some environments where multiple output devices 108 exist, it may be difficult to determine which output device 108 to connect to such that content provided from the mobile device 124 appears at the intended output device 108.

In accordance with some embodiments, a user may be able to enable the screen sharing functionality utilizing the on-site distribution network 116, the first network section 122, and an in-room remote 104. Moreover, the user may be able to modify one or more configuration setting associated with the screen sharing functionality of the output device 108 utilizing the on-site distribution network 116, the first network section 122, and an in-room remote 104.

The on-site distribution network 116, the first network 132, and the second network 140 may comprise a number of different communication media such as coaxial cable, copper cable/wire, fiber-optic cable, antennas for transmitting/receiving wireless communications, and combinations thereof. In addition, it can be appreciated that the on-site distribution network 116, the first network 132, and the second network 140 need not be limited to any one network type, and instead may be comprised of a number of different networks and/or network types. For example, the on-site distribution network 116, the first network 132, and the second network 140 may be packet-switched and/or circuit-switched. An illustrative on-site distribution network 116, first network 132, and second network 140 include, without limitation, a Wide Area Network (WAN), such as the Internet, a Local Area Network (LAN), a Personal Area Network (PAN), a Public Switched Telephone Network (PSTN), a Plain Old Telephone Service (POTS) network, a cellular communications network, an IP Multimedia Subsystem (IMS) network, a Voice over IP (VoIP) network, a SIP network, or combinations thereof. The on-site distribution network 116, the first network 132, and the second network 140 may include an Internet Protocol (IP) network including many connected computers, connected computing networks, and other connected communication devices and may support a suite of protocols including but not limited to TCP/IP. Communications supported by the on-site distribution network 116, the first network 132, and the second network 140 may include real-time, near-real-time, and non-real-time communications.

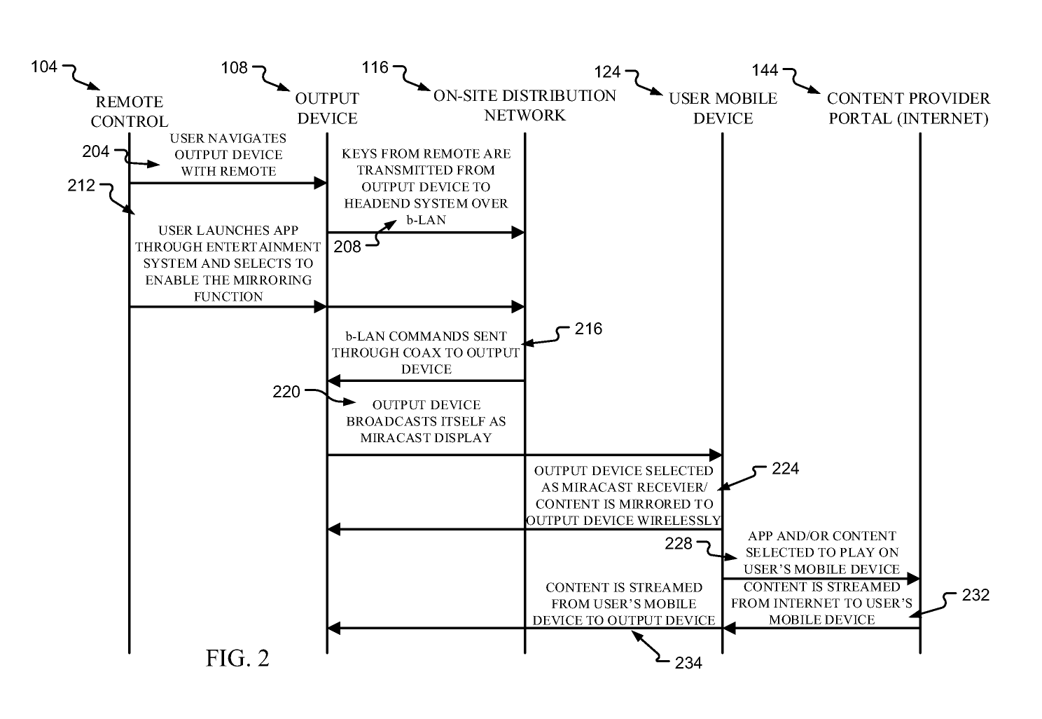

With reference now to FIG. 2, aspects of the operation of a system for implementing a screen sharing functionality, such as Miracast, initiated by a command provided over a communication network 122, such as a coax b-LAN, are depicted in accordance with embodiments of the present disclosure. Initially, at step 204, a user may utilize an in-room remote control 104 to navigate an output device 108 utilizing infrared and/or RF communication 112. For instance, the user may utilize the in-room remote 104 to navigate a SONIFI™ TV system.

Alternatively, or in addition, the user may utilize functionality of the mobile device 124 to navigate the output device 108 utilizing an application running on the mobile device. For instance, the application, or app 126, running on the mobile device 124 may communicate with an on-site distribution system 116 utilizing a second network section 148 between a hotel network 132 and the on-site distribution system 116. Of course, it should be noted that the mobile device 124 may utilize the Internet to communicate with the on-site distribution system 116 utilizing one or more aspects of the hotel network 132, the Internet 140, the hotel's external Internet connection 136, and the second segment 148.

At step 208, one or more keys (or commands) from the in-room remote 104 may be transmitted to the output device 108; however, in instances where the in-room remote 104 is associated with the on-site distribution network 116, the keys (or commands) may be routed to a headend system 118 associated with the on-site distribution network 116. For example, the keys from the remote may be transmitted from the output device 108, and/or a set top box associated with the output device 108, to the headend system 118 over the first network section 122. That is, the keys may be transmitted from the TV to the headend system 118 over the communication network 122. In instances where the mobile device 124 may be utilized to navigate the TV 108, the commands from the mobile device 124 may be received, either directly or indirectly, at the headend system 118 of the on-site distribution network 116.

Accordingly, once the keys, or commands, are received at the headend, the headend may translate or otherwise utilize the received commands to send new commands to the output device 108 through the first network section 122 (i.e. the coax b-LAN) (Step 216). Such commands may enable or otherwise turn on built-in capabilities of the output device 108. Once the Miracast screen sharing capability has been enabled, the output device 108 may begin to broadcast itself as a Miracast screen sharing display, or receiver (Step 220), capable of receiving content from a mobile device 124. Accordingly, utilizing the mobile device 124, the user may select the output device 108 as a screen sharing Miracast receiver such that the mobile device screen content is mirrored to the output device 108 wireless (Step 224). For example, a Wi-Fi Direct form of communication may be utilized to share content from the mobile device 124 to the output device 108.

Next, at step 228, a user may choose an app, such as app 114, and/or other content to be played, accessed, or otherwise utilizing their mobile device 124. For instance, the user may select an app 114 associated with one of the content providers 144 to provide content from the Internet 140 to the mobile device 124 at step 232. Once the content is received at the mobile device 124, the content is then streamed from the user's mobile device 124 to the output device 108 via Miracast 120 at step 234.

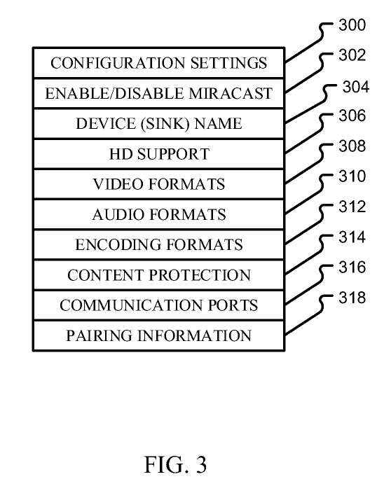

In accordance with at least some embodiments of the present disclosure, FIG. 3 provides an illustrative table of configurable settings 300 and/or parameters that may be configured and/or set in accordance with step 416 and/or 420. Such configurable settings 300 may provide additional functionality and/or customization related to the Miracast functionality of the output device 108. For instance, a parameter relating to configuration setting 302 may be provided to enable and/or disable Miracast, or screen sharing capability, at an output device 108. A parameter relating to configuration setting 304 may allow the broadcast name associated with the output device 108 to be changed. Parameter 306 may be set to indicate whether or not the output device 108 supports high definition formats and/or whether the high definition formats should be utilized. Parameters 308, 310, and 312 may be utilized to specify which video, audio, and/or encoding format should be utilized. In some instances, a preferred format may already be used and such parameters 308, 310, and 312 may be utilized to alter the preferred parameter. Similarly, parameters 314 and 316 may modify or define additional information related to content protection and/or whether existing communication ports should be modified. Moreover, in some instances, the mobile device 124 may be paired with the output device 108 such that pairing information may be required at the output device 108. Such pairing information may be provided as a parameter 318.

For example, as part of a pairing process, a required pin may be entered at the mobile device 124, where the pin entered matches a pin displayed at the output device 108. Accordingly, the mobile device 124 may receive a pin from a user, the pin may then be provided to the onsite distribution system 116, from the mobile device 124, utilizing one or more aspects of the hotel network 132, the Internet 140, the hotel's external Internet connection 136, and the second segment 148. The pin may then be provided, as pairing information 318, to the output device 108. Once the pin has been provided to the output device 108, the output device 108 and the mobile device 124 may be paired such that the mobile device 124 may stream content to the output device 108. It should be understood that configuration settings 300, such as 302-318, illustrate a subset of parameters or settings that may be utilized; more or less parameters may be utilized and are contemplated and are within the scope of the present disclosure.

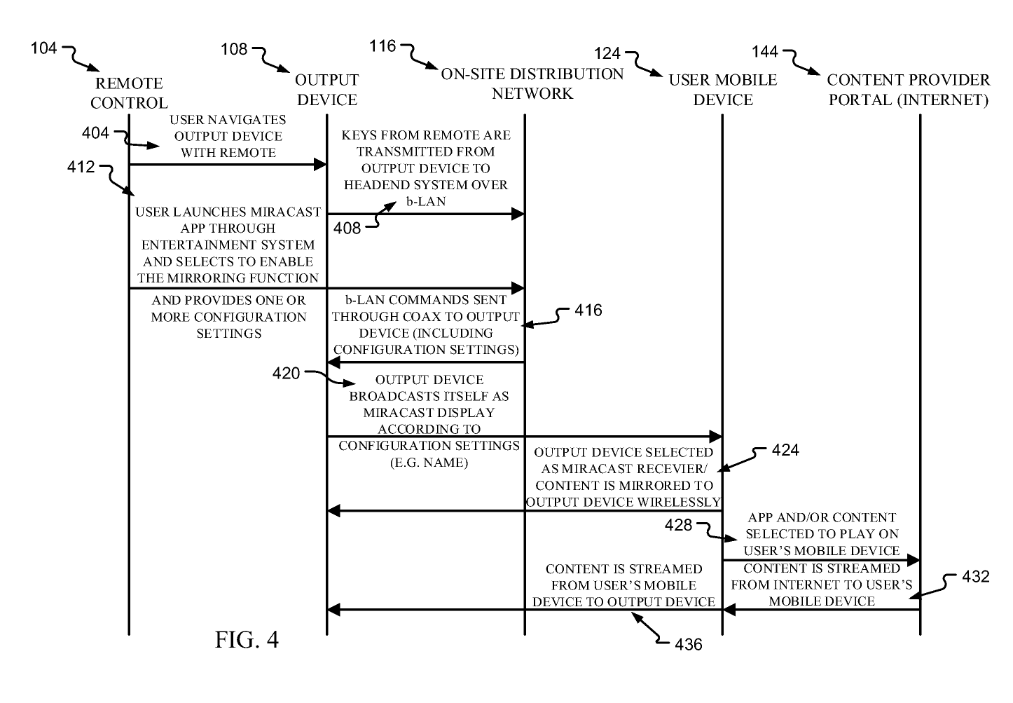

With reference now to FIG. 4, aspects of the operation of a system for implementing a screen sharing functionality, such as Miracast, initiated by a command and including configurable settings provided over a communication network 122, such as a coax b-LAN, are depicted in accordance with embodiments of the present disclosure. Similar to FIG. 2, at step 404, a user may utilize an in-room remote control 104 to navigate an output device 108 utilizing infrared and/or RF communication 112. For instance, the user may utilize the in-room remote 104 to navigate a SONIFI™ TV system.

Alternatively, or in addition, the user may utilize functionality of the mobile device 124 to navigate the output device 108 utilizing an application running on the mobile device. For instance, the application, or app 126, running on the mobile device 124 may communicate with an on-site distribution system 116 utilizing a second network section 148 between a hotel network 132 and the on-site distribution system 116. Of course, it should be noted that the mobile device 124 may utilize the Internet to communicate with the on-site distribution system 116 utilizing one or more aspects of the hotel network 132, the Internet 140, the hotel's external Internet connection 136, and the second segment 148.

At step 408, one or more keys (or commands) from the in-room remote 104 may be transmitted to the output device 108; however, in instances where the in-room remote 104 is associated with the on-site distribution network 116, the keys (or commands) may be routed to a headend system associated with the on-site distribution network 116. For example, the keys from the remote may be transmitted from the output device 108, and/or a set top box associated with the output device 108, to the headend system over the first network section 122. That is, the keys may be transmitted from the TV to the headend system over the communication network 122. In instances where the mobile device 124 may be utilized to navigate the TV, the commands from the mobile device 124 may be received, either directly or indirectly, at the headend system 118 of the on-site distribution network 116.

Accordingly, once the keys, or commands, are received at the headend, the headend may translate or otherwise utilize the received commands to send new commands to the output device 108 through the first network section 122 (i.e. the coax b-LAN) (Step 416). Such commands may enable or otherwise turn on built-in capabilities of the output device 108. In accordance with at least one embodiment of the present disclosure, the commands sent to the output device 108 through the first network section 122 may additionally include one or more parameters that alter or modify a configuration of the output device 108. For example, a command to set, or configure, the name of the output device 108 to a certain value may be received; accordingly, the output device 108 may then broadcast itself as a device capable of receiving content utilizing such a name. For example, once the screen sharing capability has been enabled, the output device 108 begins to broadcast itself as a screen sharing display, or receiver (Step 420), capable of receiving content from a mobile device 124 utilizing the previously configured name. For instance, output device 108 may broadcast itself as a Miracast sink using the specified name, such as a room number in a hospitality environment. Accordingly, utilizing the mobile device 124, the user may select the output device 108, via the broadcast name, as a screen sharing receiver such that the mobile device screen content is mirrored to the output device 108 wirelessly (Step 424). For example, a Wi-Fi direct form of communication may be utilized to share content from the mobile device 124 to the output device 108.

Next, at step 428, a user may choose an app, such as app 114, and/or other content to be played, accessed, or otherwise utilizing their mobile device 124. For instance, the user may select one of the content providers 144 to provide content from the Internet 140 to the mobile device 124. Once the content is received at the mobile device 124 at step 432, the content is then streamed from the user's mobile device 124 to the output device 108 at step 436.

In accordance with at least some embodiments of the present disclosure, and as illustrated in step 412, a user may launch an app, such as a screen sharing app 126, to enable the mirroring functionality such as Miracast. In addition, the app 126 may provide additional configuration settings in accordance with table of configurable settings 300 illustrated in FIG. 3. That is, utilizing the app 126, a user may be able to directly input, or otherwise select a Miracast sink name to be output by the output device 108. Accordingly, the output device 108 may broadcast itself as a Miracast capable device utilizing the name input at step 412. Alternatively, or in addition, one or more configuration settings described with respect to the table of configuration settings 300 depicted in FIG. 3 may be received, altered, and/or modified at step 412.

Similarly, at step 404, as a user navigates the output device 108 with the remote 104, the user may be able to configure one or more configurable settings as described with respect to the table of configurable settings 300 illustrated in FIG. 3. For example, the user may be able to navigate an on screen display to change or modify the Miracast sink name associated with the output device 108. Such configurable parameters and keys may be transmitted from the output device 108, and/or a set top box associated with the output device 108, to the headend system 118 over the first network section 122. That is, the keys and one or more configurable parameters, as illustrated in FIG. 3 for instance, may be transmitted from the TV to the headend system 118 over the communication network 122. Accordingly, once the keys, or commands and/or configurable parameters, are received at the headend, the headend may translate or otherwise utilize the received commands to send new commands to the output device 108 through the first network section 122 (i.e., the coax b-LAN). Such commands may enable or otherwise turn on built-in capabilities of the output device 108 and/or modify one or more configurable parameters.

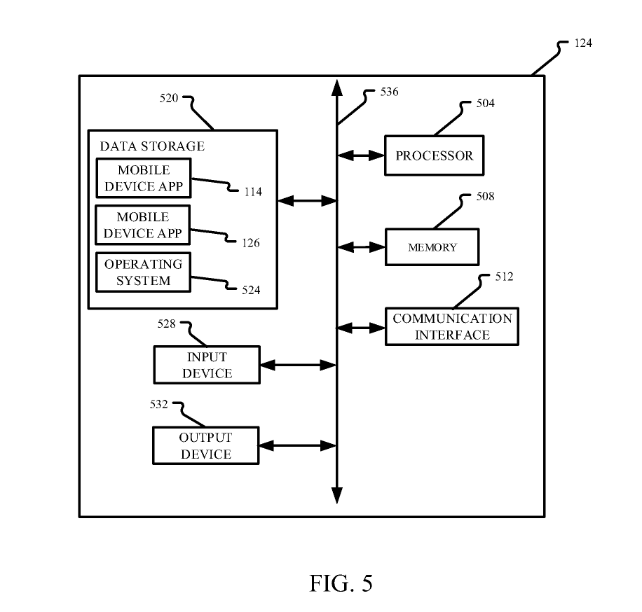

FIG. 5 is a block diagram illustrating components of a mobile device 124 in accordance with embodiments of the present disclosure. In general, a mobile device 124 includes a processor 504 and memory 508. The processor 504 may comprise a general purpose programmable processor or controller for executing application programming or instructions. As a further example, the processor 504 may comprise a specially configured application specific integrated circuit (ASIC). The processor 504 generally functions to run programming code or instructions, such as applications or programs, implementing various functions of the mobile device 124. The memory 508 is generally used in connection with the execution of application programming by the processor 504, and for the temporary or long term storage of program instructions and/or data. As examples, the memory 508 may comprise removable secure digital storage, RAM, SDRAM, or other solid-state memory.

A mobile device 124 may also include data storage 520. In accordance with embodiments of the present invention, data storage 520 may contain program code or instructions implementing various applications or functions executed by the mobile device 124. Like the memory 508, the data storage 520 may comprise a solid-state memory device. In addition, in certain applications, the data storage 520 may be integrated with and/or indistinguishable from the memory 508. Alternatively or in addition, the data storage 520 may comprise a hard disk drive or other random access memory, and/or can be interconnected to the mobile device 124, for example as network attached storage. Programming or modules stored in the data storage 520 and executed by the processor 504 can include, a mobile device app, such as an app 114 associated with a content provider 144, a mobile device app, such as an app 126 associated with a screen sharing functionality of the mobile device 124, and an operating system 524.

In addition, the mobile device 124 may include user input device 528 and user output device 532 and may be used to receive and or display information in connection with the mobile device 124. For example, a user may enter information, select a configurable setting, and/or initiate a communication or browsing session utilizing the input device 528, with one or more content providers 144. Content received at the mobile device 124 may be displayed via the output device 532. Examples of a user input device 528 include, but are not limited to, a keyboard, a numeric keypad, a touch screen, and a pointing device. Examples of a user output device 532 include, but are not limited to, a display, a touch screen display, and a speaker.

The mobile device 124 may also include one or more communication interfaces 512. The one or more communication interfaces 512 may provide access to the wireless network 128 and/or enable a direct device-to-device communication, such as Wi-Fi Direct, and provide the connection medium for utilizing a screen sharing capability, such as Miracast. The processor 504, memory 508, communication interface 512, data storage 520, user input device 528, and user output device 532 may communicate with each other utilizing a communication bus 536.

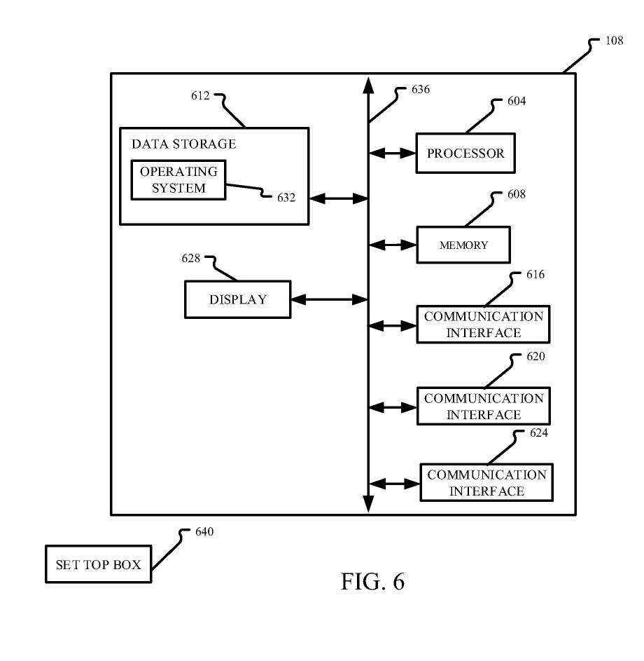

FIG. 6 is a block diagram illustrating components of an output device 108 in accordance with embodiments of the present disclosure. In general, an output device 108 includes a processor 604 and memory 608. The processor 604 may comprise a general purpose programmable processor or controller for executing application programming or instructions. As a further example, the processor 604 may comprise a specially configured application specific integrated circuit (ASIC). The processor 604 generally functions to run programming code or instructions, such as applications or programs, implementing various functions of the output device 108. The memory 608 is generally used in connection with the execution of application programming by the processor 604, and for the temporary or long term storage of program instructions and/or data. As examples, the memory 608 may comprise removable secure digital storage, RAM, SDRAM, or other solid-state memory.

An output device 108 may also include data storage 612. In accordance with embodiments of the present invention, data storage 612 may contain program code or instructions implementing various applications or functions executed by the output device 108. Like the memory 608, the data storage 612 may comprise a solid-state memory device. In addition, in certain applications, the data storage 612 may be integrated with and/or indistinguishable from the memory 608. Alternatively or in addition, the data storage 612 may comprise a hard disk drive or other random access memory. Programming or modules stored in the data storage 612 and executed by the processor 604 can include, functionality related to receiving one or more commands from the on-site distribution network 116, displaying content at an output or display 628, and or instructions generally related an operating system 632.

In addition, an output device 108 may include one or more communication interfaces, such as communication interface 616 connecting the output device 108 to the first network section 122 and a communication interface 620, connecting the output device 108 to a mobile device 124 as previously described. The output device 108 may additionally include communication interface 624 for communicating with a remote 104. Content received directly from the mobile device 124 may be displayed at the display 628. The various components of output device 108 may communicate with one another utilizing a bus 636. It should be further understood that some components and/or functionality described with respect to the output device 108 may be included in a set top box 640. That is, the set top box 640 may reside between the display device 108 and one or more of the previously described communication networks and may provide functionality that is similar to or the same as that which has been described with respect to the output device 108.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A system for implementing a screen sharing functionality over a communication network, comprising:
a distribution network;
an output device, wherein one or more first commands are received at a headend of the distribution network, the one or more first commands indicating that a screen sharing functionality of the output device is to be configured, wherein the headend device provides one or more second commands to the output device over a communication network such that the received one or more second commands at the output device configures the screen sharing functionality of the output device,
wherein the output device is configured to receive and display content from a mobile device.

2. The system of claim 1, wherein the one or more first commands indicate that a broadcast name associated with the screen sharing functionality of the output device is to be configured.

3. The system of claim 1, wherein the one or more second commands indicate that a broadcast name associated with the screen sharing functionality of the output device is to be configured.

4. The system of claim 3, wherein the output device broadcasts the broadcast name associated with the screen sharing functionality of the output device.

5. The system of claim 1, wherein the communication network includes a coax Broadband Local Area Network (b-LAN) communication network.

6. The system of claim 5, wherein the second commands are provided to the output device over the b-LAN communication network.

7. The system of claim 6, wherein the output device is configured to receive and display content directly from the mobile device using a direct device-to-device communication protocol.

8. A method for implementing screen sharing functionality, the method comprising:
receiving, one or more first commands that enable the screen sharing functionality at a headend of a distribution network;
providing one or more second commands based on the one or more first commands to an output device, the one or more second commands enabling one or more screen sharing capabilities of the output device;
receiving, by the output device, content provided from a mobile device; and
outputting, by the output device, the received content.

9. The method of claim 8, further comprising:
providing one or more third commands to the output device, the one or more third commands modifying one or more screen sharing configuration settings of the output device; and
broadcasting, by the output device, a broadcast name associated with the screen sharing functionality of the output device, wherein the broadcast name is based on the one or more third commands.

10. The method of claim 8, further comprising:
receiving, at an output device, the one or more first commands that enable the screen sharing functionality; and
providing the one or more first commands that enable the screen sharing functionality to the headend of the distribution network.

11. The method of claim 8, further comprising:
receiving, from a mobile device, the one or more first commands that enable the screen sharing functionality.

12. The method of claim 8, further comprising:
receiving, from a remote, the one or more first commands that enable the screen sharing functionality.

13. The method of claim 8, wherein the one or more second commands are provided over a coax Broadband Local Area Network (b-LAN) communication network.

14. The method of claim 13, wherein the one or more third commands are provided to the output device over the b-LAN communication network.

15. The method of claim 8, further comprising:
receiving, by the output device, content directly provided from a mobile device using a direct device-to-device communication protocol.

16. A non-transitory computer-readable medium comprising one or more instructions that when executed by one or more processors, performs a method, the method comprising:
providing, by a device, one or more commands to enable a screen sharing functionality of an output device;
receiving, at the device, an indication to select a broadcast name associated with the output device; and
providing content to the output device.

17. The non-transitory computer-readable medium of claim 16, further comprising:
receiving, at the device, an indication to enable a screen sharing functionality of an output device.

18. The non-transitory computer-readable medium of claim 17, wherein the one or more commands are provided to a headend utilizing a first communication network, and the content is provided to the output device using a second communication network.

19. The non-transitory computer-readable medium of claim 18, further comprising:
receiving, at the device, content from a third communication network.

20. The non-transitory computer-readable medium of claim 16, further comprising:
providing, to the output device, content directly from the device using a direct device-to-device communication protocol.
